(19) United States
(12) Patent Application Publication
(10) Pub. No.: US 2015/0050900 A1
(43) Pub. Date: Feb. 19, 2015

(54) VOLTAGE REGULATING CIRCUIT AND METHOD THEREOF

(71) Applicant: REALTEK SEMICONDUCTOR CORP., Hsinchu (TW)

(72) Inventor: Bin ZHANG, Hsinchu (TW)

(73) Assignee: REALTEK SEMICONDUCTOR CORP., Hsinchu (TW)

(21) Appl. No.: 14/327,080

(22) Filed: Jul. 9, 2014

(30) Foreign Application Priority Data
Aug. 16, 2013 (CN) 201310359218.1

(51) Int. Cl. H04B 1/04; H02M 1/08

(52) U.S. Cl. CPC H04B 1/04; H02M 1/08; H04B 2001/0433
USPC 455/127.1; 323/282

(57) ABSTRACT

A voltage regulating circuit and a method thereof are provided. The voltage regulating circuit includes: a tank circuit, an error amplifier, an output circuit, and a feedback circuit. The tank circuit provides a fixed voltage. The error amplifier generates an amplified voltage according to a reference voltage and a feedback voltage. The output circuit converts a supply voltage into an output voltage in response to at least one of the amplified voltage and the fixed voltage. The feedback circuit generates a feedback voltage according to the output voltage.

### CROSS-REFERENCES TO RELATED APPLICATIONS

This non-provisional application claims priority under 35 U.S.C. §119(a) on Patent Application No. 201310359218.1 filed in China, P.R.C. on Aug. 16, 2013, the entire contents of which are hereby incorporated by reference.

### BACKGROUND

1. Technical Field

The present invention relates to a technology for providing a stable voltage, and in particular, to a voltage regulating circuit and a method thereof.

2. Related Art

A voltage regulator is a device for converting a supply voltage into a stable output voltage, and is generally disposed between a power supply and a load circuit. A good voltage regulator provides a stable output voltage, and is capable of stabilizing the output voltage rapidly when a load changes, so as to provide the load with a required load current. In most voltage regulators, an error amplifier is adopted to control an ON/OFF state of a power element according to a comparison result between a feedback voltage and a reference voltage, and a supply voltage is converted by the power element into an output voltage.

In an advanced wireless communication transceiver, a receiver (RX) and a transmitter (TX) are started in an alternating way, which means that the receiver and the transmitter will not be started at the same time. The receiver is started only at a burst when a communication package is about to be transmitted.

In other words, an interval period usually appears during signal transmission, and in the interval period, a signal output terminal takes on a high impedance (hi-Z) state. When data transmission needs to be started, i.e., when the signal output terminal suddenly switches from hi-Z (namely, a standby mode) to outputting “0”, “1”, or data streams (namely, a normal working mode), the voltage regulator needs to provide a large load current and a stable output voltage within extremely short time. However, a closed-loop bandwidth (CLBW) in the voltage regulator has a certain start time response, which results in an amplitude fluctuation of the output signal at an initial stage, for example, the amplitude is too small or too large.

### SUMMARY

In an embodiment, a voltage regulating circuit includes: a tank circuit, an error amplifier, an output circuit, and a feedback circuit.

The error amplifier is electrically connected to the tank circuit. The output circuit is electrically connected to the tank circuit and the error amplifier.

The tank circuit provides a fixed voltage. The error amplifier generates an amplified voltage according to a reference voltage and a feedback voltage. The output circuit converts a supply voltage into an output voltage in response to at least one of the amplified voltage and the fixed voltage. Herein, the feedback voltage is related to the output voltage.

In an embodiment, a voltage regulating method includes: generating an amplified voltage according to a difference between a reference voltage and a feedback voltage; providing a fixed voltage by using an energy storage capacitor; converting a supply voltage into an output voltage in response to at least one of the amplified voltage and the fixed voltage; and generating a feedback voltage according to the output voltage.

In another embodiment, the voltage regulating method is applied to a wireless transmission system, and the wireless transmission system has an energy storage capacitor, a feedback loop, and a signal transmission circuit. In the voltage regulating method, at a preset stage of the wireless transmission system, the energy storage capacitor is connected to an error amplifier in the feedback loop, and the energy storage capacitor is charged with an amplified voltage generated by the error amplifier. When the feedback loop enters a stable state, the energy storage capacitor is disconnected from the error amplifier. During a normal working stage of the wireless transmission system, the feedback loop is started, and the energy storage capacitor is connected to a control terminal of a power element in the feedback loop, so that the power element generates an output voltage to the signal transmission circuit based on the control of the energy storage capacitor and the error amplifier.

In sum, in the voltage regulating circuit and the method thereof according to the present invention, the tank circuit is used to ensure that once becoming stable after startup, the terminal voltage at the control terminal of the output circuit does not change significantly. Once the data signal output terminal enters the high impedance state, the tank circuit is disconnected from the output circuit, so that the fixed voltage of the tank circuit is locked at a voltage value capable of providing a large current. Once the data signal needs to be outputted, the tank circuit is connected to the output circuit, and the feedback loop is started, so that the tank circuit provides a stable voltage that enables an output level to output a large current. In this way, response time before a feedback loop enters a stable state is reduced or eliminated, thereby effectively reducing the amplitude fluctuation during initial transmission stage of the data signal.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a first embodiment of a voltage regulating circuit according to the present invention;

FIG. 2 is a schematic view of a second embodiment of a voltage regulating circuit according to the present invention;

FIG. 3 is a schematic view of a first embodiment of a wireless transmission system according to the present invention;

FIG. 4 is a schematic view of a second embodiment of a wireless transmission system according to the present invention;

FIG. 5 is a schematic view of a first embodiment of a time sequence relationship of related signals in FIG. 1 or FIG. 2; and

FIG. 6 is a schematic view of a second embodiment of a time sequence relationship of related signals in FIG. 1 or FIG. 2.

### DETAILED DESCRIPTION

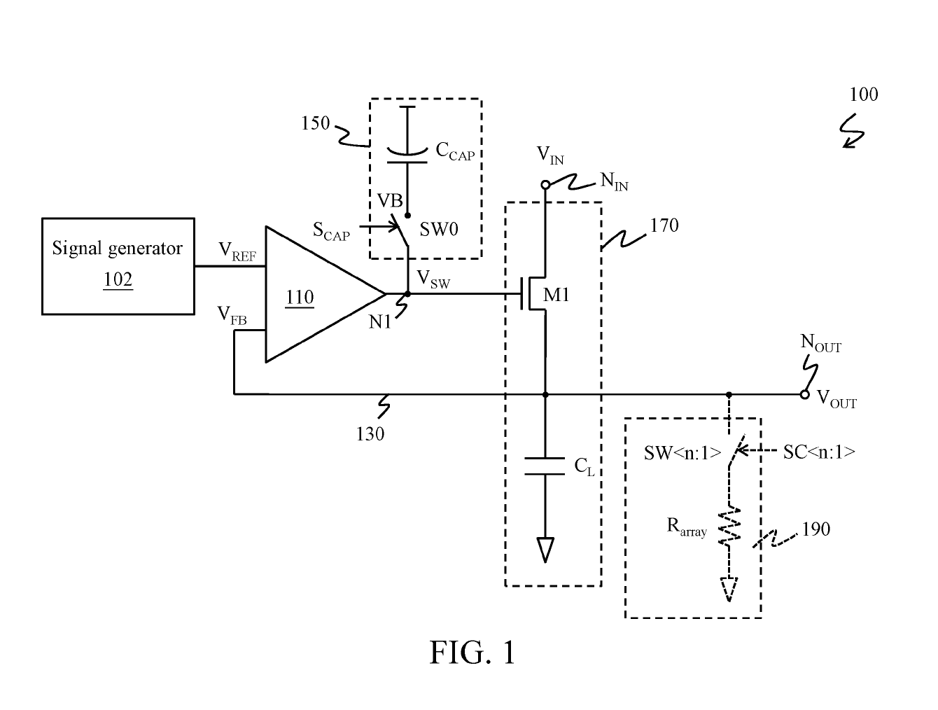

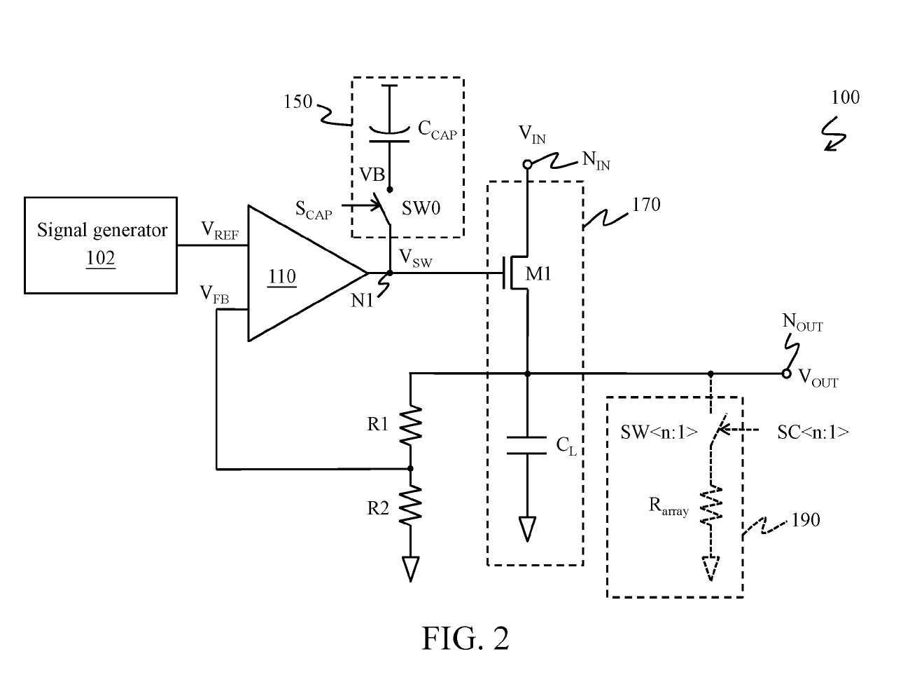

Referring to FIG. 1 and FIG. 2, a voltage regulating circuit 100 includes an error amplifier 110, a tank circuit 150, and an output circuit 170.

An output terminal of the error amplifier 110 is electrically connected to a control terminal of the output circuit 170 and the tank circuit 150 through a first contact N1. An input terminal of the output circuit 170 is electrically connected to a power contact NIN, and an output terminal of the output circuit 170 is electrically connected to a load contact NOUT.

A feedback path is provided between the load contact NOUT and a first input terminal of the error amplifier 110, so as to form a feedback loop. A second input terminal of the error amplifier 110 is electrically connected to a reference voltage VREF, and the reference voltage VREF is provided by a signal generator 102. The signal generator 102 may be an external component of the voltage regulating circuit 100 or an internal component of the voltage regulating circuit 100.

The first input terminal of the error amplifier 110 receives a feedback voltage VFB, and the feedback voltage VFB is related to the output voltage VOUT. The error amplifier 110 generates an amplified voltage according to a difference between the feedback voltage VFB and the reference voltage VREF.

In a charging state, the tank circuit 150 is charged with the amplified voltage, so that the tank circuit 150 stores a fixed voltage. Therefore, the fixed voltage is equivalent to the amplified voltage. Furthermore, in a discharging state, the tank circuit 150 provides this fixed voltage to the output circuit 170.

The output circuit 170 generates an output voltage VOUT corresponding to a supply voltage VIN in response to a voltage value at the control terminal thereof (namely, a terminal voltage VSW of the first contact N1). Herein, the terminal voltage VSW is equivalent to at least one of the amplified voltage and the fixed voltage.

In some embodiments, the output circuit 170 may include a power element M1. The power element M1 has a first terminal, a second terminal, and a control terminal. The control terminal of the power element M1 is electrically connected to the output terminal of the error amplifier 110 and the tank circuit 150. The first terminal of the power element M1 is electrically connected to the power contact NIN, and receives the supply voltage VIN provided by the power contact NIN. The second terminal of the power element M1 is electrically connected to the load contact NOUT. The power element M1 converts the supply voltage VIN into the output voltage VOUT, and provides the output voltage VOUT at the second terminal of the power element M1. Herein, the power element M1 may be a PMOS transistor or an NMOS transistor.

In some embodiments, the tank circuit 150 may include an energy storage capacitor CCAP and a first switch SW0. The energy storage capacitor CCAP is electrically connected between the voltage source and the first switch SW0. A first terminal of the first switch SW0 is electrically connected to the energy storage capacitor CCAP, and a second terminal of the first switch SW0 is electrically connected to the output terminal of the error amplifier 110 and the control terminal of the output circuit 170 (the control terminal of the power element M1), namely, the first contact N1. A control terminal of the first switch SW0 receives a switch signal SCAP, and controls connection/disconnection between the energy storage capacitor CCAP and the first contact N1 according to the switch signal SCAP, so as to determine a charging/discharging time of the energy storage capacitor CCAP.

Herein, the feedback path may be implemented in the form of a signal line 130 or a divider resistance circuit.

In some embodiments, referring to FIG. 1, a signal line 130 may be coupled between the load contact NOUT and the first input terminal of the amplifier 110, so as to directly provide the output voltage VOUT as the feedback voltage VFB to the error amplifier 110 through the signal line 130.

In some embodiments, referring to FIG. 2, a divider resistance circuit may be coupled between the load contact NOUT and the first input terminal of the amplifier 110. Herein, the divider resistance circuit may include a first resistor R1 and a second resistor R2. The first resistor R1 is electrically connected between the first input terminal of the error amplifier 110 and ground. The second resistor R2 is electrically connected between the load contact NOUT (namely, the output terminal of the output circuit 170) and the first input terminal of the error amplifier 110. Herein, a partial voltage of the output voltage VOUT obtained through the first resistor R1 and the second resistor R2 is used as the feedback voltage VFB, and the feedback voltage VFB is provided to the error amplifier 110.

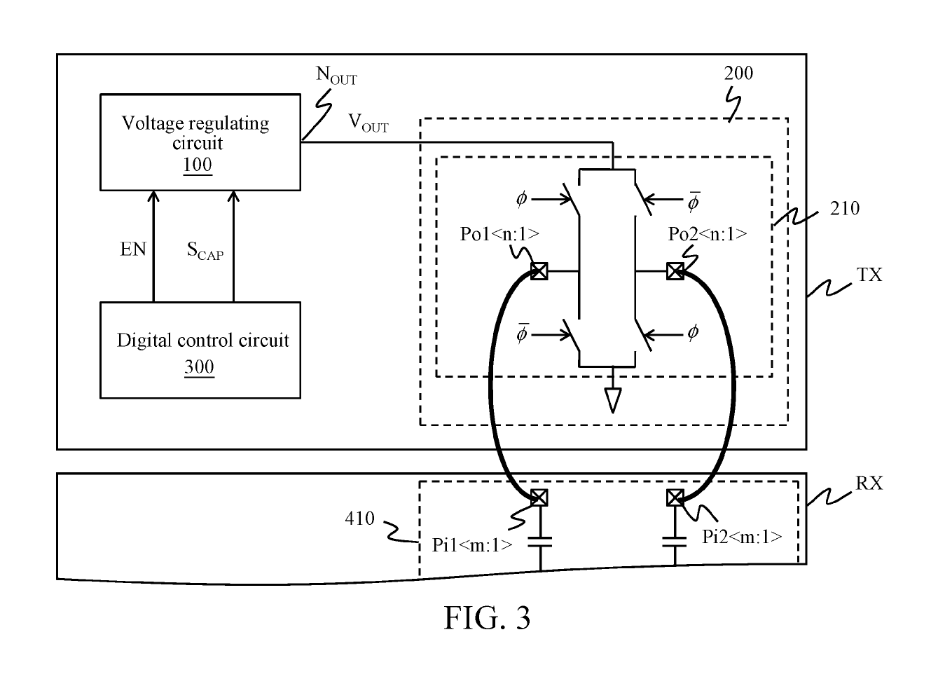

A signal transmission system is taken as an example to describe the operation of the voltage regulating circuit 100. Referring to FIG. 3, a signal transmission system TX includes a voltage regulating circuit 100, a signal transmission circuit 200, and a digital control circuit 300.

The digital control circuit 300 is electrically connected to a control terminal of a first switch SW0 of the voltage regulating circuit 100 and a control terminal of an error amplifier 110. The digital control circuit 300 generates a switch signal SCAP for controlling the first switch SW0 and an enabling signal EN for controlling the error amplifier 110, so as to determine an operation state of the first switch SW0 and the error amplifier 110.

The signal transmission circuit 200 has one or more signal output terminals 210. Each signal output terminal 210 is electrically connected between a load contact NOUT and ground.

Each signal output terminal 210 may be in a differential form or in a single-terminaled form. Taking the differential form for example, each signal output terminal 210 has two output pins Po1<n:1> and Po2<n:1>, and a plurality of output switches. The output pin Po1<n:1> of each signal output terminal 210 is connected to the load contact NOUT and ground through two output switches which are controlled by two complementary switch signals φ and φ̅ respectively. The output pin Po2<n:1> of each signal output terminal 210 is connected to the load contact NOUT and ground through other two output switches which are controlled by two complementary switch signals φ and φ̅. Moreover, in the same signal output terminal 210, when the output pin Po1<n:1> is connected to the load contact NOUT and disconnected from the ground through the output switches, the output pin Po2<n:1> is disconnected from the load contact NOUT through the output switch but is connected to the ground. Herein, the output pins Po1<n:1> and Po2<n:1> in the signal transmission circuit 200 of the signal transmission system TX are connected in a wired or wireless manner to corresponding input pins Pi1<m:1> and Pi2<m:1> in at least one signal input terminal 410 of another signal transmission system RX, where m and n are both positive integers.

The voltage regulating circuit 100 has a preset stage P0, a standby stage P1, and a normal working stage P2. Herein, the preset stage P0 refers to an initialization stage after the startup of the signal transmission system TX. After the startup of the signal transmission system TX, the signal transmission system TX proceeds to a period when a data signal is about to be transmitted but is not transmitted yet, namely, the standby stage P1. In other words, in the standby stage P1, the signal output terminal 210 is in a high impedance state. A period when the signal transmission system TX transmits data signals is known as the normal working stage P2. In some embodiments, the signal transmission circuit 200 may output data signals intermittently, that is, the signal transmission system TX enters the normal working stage P2 intermittently.

In some embodiments, in the preset stage P0, the first switch SW0 connects the energy storage capacitor CCAP and the first contact N1 in response to the switch signal SW0. Moreover, one output switch of the signal output terminal 210 responds to the switch signals φ and φ̅ respectively and connects the output pin Po1<n:1> and Po2<n:1> to the load contact NOUT and ground respectively.

A controller of the signal transmission system TX generates a test signal, and transmits the test signal through the output pins Po1<n:1> and Po2<n:1>. Herein, a current consumed during signal transmission of the signal transmission system TX is uncertain. For example, the signal input terminal 410 is an alternating current (AC) coupling circuit, that is to say, direct current (DC) input resistance is infinite. Therefore, as for the signal output terminal 210, the consumed current is related to a working frequency, and different application frequencies require the voltage regulating circuit 100 to provide different currents. The test signal is used to simulate the current consumed by the signal transmission system TX during the normal working stage P2. In other words, the test signal has a set frequency, that is, the interval frequency and/or probability at which “1” and “0” appear in the test signal is the approximate to that of the data signals transmitted in the normal working stage P2.

At the same time, the enabling signal EN is used to enable the error amplifier 110, so that the feedback loop starts operating. At this time, the feedback path provides a feedback voltage VFB to the error amplifier 110 according to the terminal voltage of the load contact NOUT (namely, the current output voltage VOUT). The error amplifier 110 generates an amplified voltage (namely, a terminal voltage VSW) according to a difference between the reference voltage VREF and the feedback voltage VFB, and charges the energy storage capacitor CCAP with this amplified voltage, so as to set up an appropriate terminal voltage VSW at the first contact N1.

The appropriate terminal voltage VSW herein refers to that a voltage value of the terminal voltage VSW is sufficient for the power element M1 to provide an output voltage VOUT required by an external load. A setup time of the terminal voltage VSW is generally proportional to the bandwidth of the feedback loop. That is, the setup time increases as the bandwidth decreases.

After the feedback loop of the voltage regulating circuit 100 enters a stable state (namely, the appropriate terminal voltage VSW is set up), the first switch SW0 disconnects the energy storage capacitor CCAP from the first contact N1 in response to the switch signal SW0, so that the energy storage capacitor CCAP clamps the terminal voltage VSW, that is, the voltage value stored in the energy storage capacitor CCAP is equivalent to the fixed voltage of the terminal voltage VSW during the stable state. Subsequently, the voltage regulating circuit 100 enters the standby stage P1.

In other words, at the standby stage P1, the first switch SW0 is OFF, and the signal transmission system TX stops transmitting the test signal. The error amplifier 110 also stops operating in response to the enabling signal EN. At this time, the energy storage capacitor CCAP stores a fixed voltage.

When the signal transmission system TX is about to transmit a data signal, the signal transmission system TX enters the normal working stage P2. In the normal working stage P2, the enabling signal EN is used to enable the error amplifier 110, so that the feedback loop starts operating. At the same time, the first switch SW0 connects the energy storage capacitor CCAP to the first contact N1 in response to the switch signal SW0, so that the energy storage capacitor CCAP discharges electricity. At the this time, a large current starts to flow out of the load contact NOUT and is output to an external load (namely, the signal output terminal 210 that transmits the data signal). Herein, the fixed voltage stored in the energy storage capacitor CCAP is used to pull the terminal voltage VSW of the first contact N1 to a voltage value required at the stable state. Therefore, a current flowing out of the power element M1 is not significantly different from that in the preset stage P0, so that it does not take a long time for the voltage regulating circuit 100 to catch up with the stable state. In this way, the electrical performance during the output of the first data batch of data signals is ensured.

In other words, the capacitance of the energy storage capacitor CCAP is much larger than the parasitic capacitance at the control terminal of the power element M1, so the terminal voltage VSW of the first contact N1 can have a stable voltage value that enables an output level (namely, the output circuit 170) to provide a large current without a large quantity of electric charges provided by a previous error amplifier 110. Moreover, it is also feasible to increase a quiescent current of the error amplifier 110 when the error amplifier 110 is just started, so as to reduce the bandwidth of the feedback loop. After the voltage regulating circuit 100 becomes stable, the current is restored to a normal state. Therefore, the electrical performance of the output data signal is not significantly different during the initial transmission stage.

In some other embodiments, referring to FIG. 1 and FIG. 2, the voltage regulating circuit 100 may further include an impedance circuit 190. The impedance circuit 190 is a variable resistor array, and provides an impedance matching the signal output terminal 210 during the normal working stage P2 when the energy storage capacitor CCAP is charged.

In some embodiments, the impedance circuit 190 may include one or more impedance switches SW<n:1> and one or more impedors R_{array}; each of the impedance switches SW<n:1> is corresponding to one of the impedors R_{array}. In this embodiment, the impedance switches SW<n:1> are one-to-one mapped to the impedors R_{array}. The impedance switch SW<n:1> is electrically connected between the corresponding impedor R_{array} and the load contact NOUT.

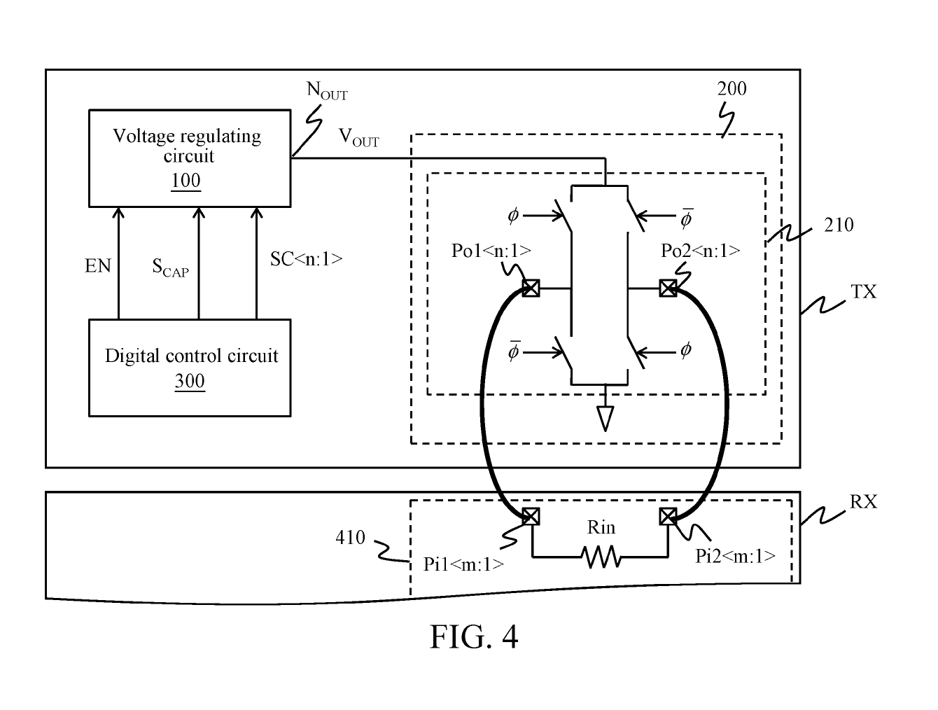

Referring to FIG. 1, FIG. 2, and FIG. 4, at the preset stage P0, the first switch SW0 connects the energy storage capacitor CCAP and the first contact N1 in response to the switch signal SW0. The digital control circuit 300 generates a switch signal SC<n:1> according to a signal channel (namely, the electrically connected signal output terminal 210 and signal input terminal 410) where data signals are transmitted during the normal working stage P2, so that the impedance switch SW<n:1> connects the corresponding impedor R_{array} and the load contact NOUT in response to the switch signal SC<n:1>.

Herein, the number of impedance switches SW<n:1> in an ON state is corresponding to signal channels where data signals are transmitted during the normal working stage P2, so that the impedor R_{array} provides a specific impedance to the load contact NOUT. The specific impedance is equivalent to the impedance of the signal channel where data signals are transmitted during the normal working stage P2, namely, a sum of an equivalent impedance (ROUT) of the signal output terminal 210 where data signals are transmitted and an impedance RIN of the signal input terminal 410 (R_{array}=ROUT+RIN).

In some embodiments, the number of impedors R_{array} may be corresponding to the number of signal output terminals 210, and the impedances of these impedors R_{array} are one-to-one mapped to the impedances of the signal output terminals 210. Therefore, if the signal output terminals 210 where data signals are transmitted during the normal working stage P2 are a first group of signal output terminals (namely, the output pins Po1<1> and Po2<1>), when the energy storage capacitor CCAP is charged, a first impedance switch SW<1> is turned on. In the same way, if the signal output terminals 210 where data signals are transmitted during the normal working stage P2 are a second group of signal output terminals (namely, the output pins Po1<2> and Po2<2>), when the energy storage capacitor CCAP is charged, a second impedance switch SW<2> is turned on. The rest can be done in the same manner.

At the same time, the enabling signal EN is used to enable the error amplifier 110, so that the feedback loop starts operating. At this time, the feedback path provides a feedback voltage VFB to the error amplifier 110 according to the terminal voltage of the load contact NOUT (namely, the current output voltage VOUT). The error amplifier 110 generates an amplified voltage (namely, a terminal voltage VSW) according to a difference between the reference voltage VREF and the feedback voltage VFB, and charges the energy storage capacitor CCAP with this amplified voltage, so as to set up an appropriate terminal voltage VSW at the first contact N1.

After the feedback loop of the voltage regulating circuit 100 enters a stable state (namely, the appropriate terminal voltage VSW is set up), the first switch SW0 disconnects the energy storage capacitor CCAP from the first contact N1 in response to the switch signal SW0, and the impedance switch SW<n:1> disconnects the impedor R_{array} from the load contact NOUT in response to the switch signal SC<n:1>. Subsequently, the voltage regulating circuit 100 enters the standby stage P1.

In other words, at the standby stage P1, the first switch SW0 and the impedance switch SW<n:1> are turned off. The error amplifier 110 also stops operating in response to the enabling signal EN. At this time, the energy storage capacitor CCAP stores a fixed voltage.

In the normal working stage P2, the enabling signal EN is used to enable the error amplifier 110, so that the feedback loop starts operating. At the same time, the first switch SW0 connects the energy storage capacitor CCAP and the first contact N1 in response to the switch signal SW0, so that the energy storage capacitor CCAP discharges electricity. At this time, the impedance switch SW<n:1> still maintains an OFF state, so that a large current generated by the power element M1 is output from the load contact NOUT to an external load (namely, the signal output terminal 210 where data signals are transmitted).

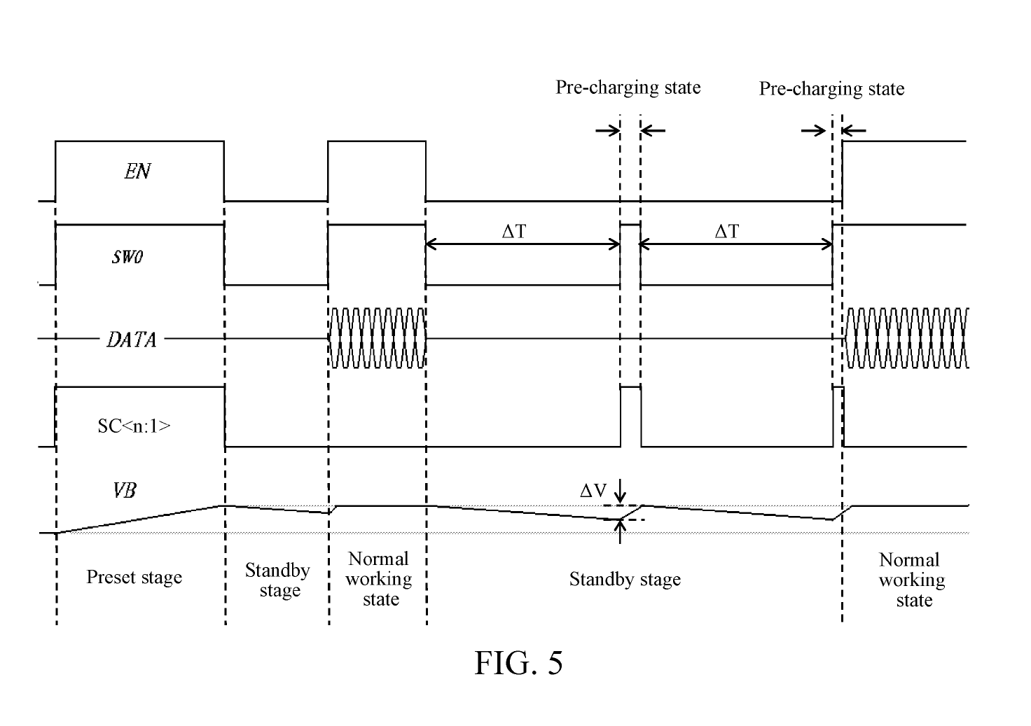

In some embodiments, when a PMOS transistor is used as the power element M1, a time sequence relationship among the enabling signal EN, the switch signal SW0, the data signal DATA, the switch signal SC<n:1>, and the terminal voltage VB at the first terminal of the first switch SW0 is shown in FIG. 5.

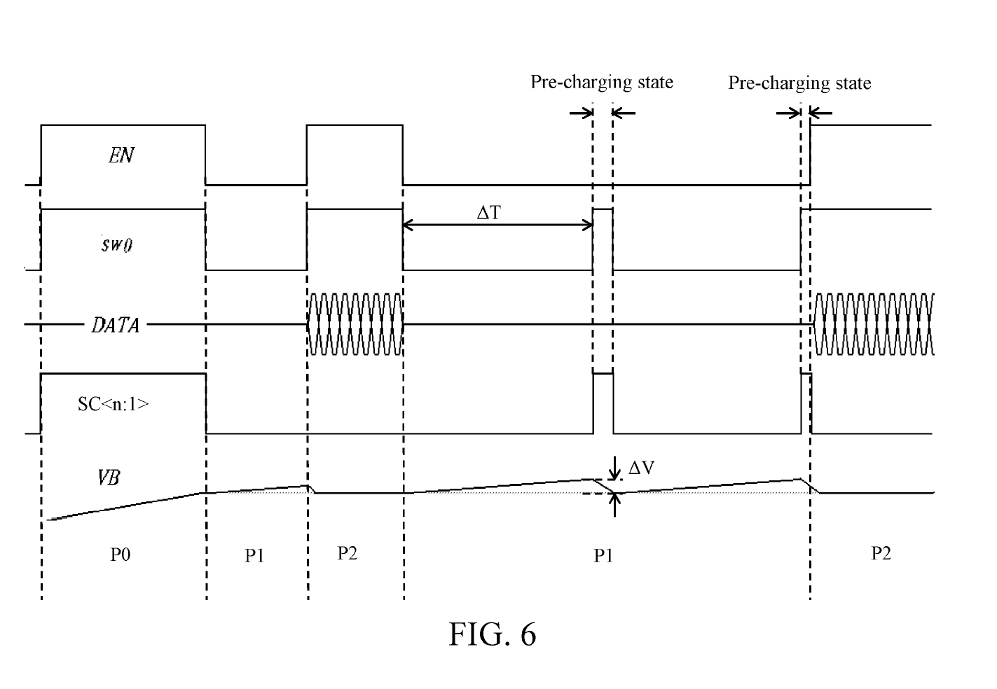

In some embodiments, when an NMOS transistor is used as the power element M1, a time sequence relationship among the enabling signal EN, the switch signal SW0, the switch signal SC<n:1>, and the terminal voltage VB at the first terminal of the first switch SW0 is shown in FIG. 6.

In the two types of charging architecture described above (using a test signal or using an impedance circuit 190), the energy storage capacitor CCAP may also be charged during the standby stage P1 and normal working stage P2.

In some embodiments, the signal transmission system TX starts timing after the preset stage P0 is finished, enters a pre-charging state at a time interval ΔT, and charges the energy storage capacitor CCAP with architecture identical to that of the preset stage P0.

In some embodiments, the signal transmission system TX detects the fixed voltage stored in the energy storage capacitor CCAP, namely, detecting a drift ΔV of the terminal voltage VB. When the drift ΔV is greater than a threshold, the signal transmission system TX enters a pre-charging state and charges the energy storage capacitor CCAP with architecture identical to that of the preset stage P0.

In sum, in the voltage regulating circuit and the method thereof according to the present invention, the tank circuit is used to ensure that once becoming stable after startup, the terminal voltage at the control terminal of the output circuit does not change significantly. Once the data signal output terminal enters the high impedance state, the tank circuit is disconnected from the output circuit, so that the fixed voltage of the tank circuit is locked at a voltage value capable of providing a large current. Once the data signal needs to be outputted, the tank circuit is connected to the output circuit, and the feedback loop is started, so that the tank circuit provides a stable voltage that enables an output level to output a large current. In this way, response time before a feedback loop enters a stable state is reduced or eliminated, thereby effectively reducing the amplitude fluctuation during initial transmission stage of the data signal.

While the present invention has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A voltage regulating circuit, comprising:
a tank circuit, providing a fixed voltage;
an error amplifier, electrically connected to the tank circuit, generates an amplified voltage according to a reference voltage and a feedback voltage; and
an output circuit, electrically connected to the tank circuit and the error amplifier, converting a supply voltage into an output voltage according to at least one of the amplified voltage and the fixed voltage, wherein the feedback voltage is related to the output voltage.

2. The voltage regulating circuit according to claim 1, wherein the tank circuit comprises:
an energy storage capacitor, for storing the fixed voltage; and
a first switch, electrically connected between the energy storage capacitor and an output terminal of the error amplifier.

3. The voltage regulating circuit according to claim 2, wherein the output circuit comprises:
a power element, a control terminal of the power element being electrically connected to the output terminal of the error amplifier, for converting the supply voltage into the output voltage.

4. The voltage regulating circuit according to claim 3, wherein capacitance of the energy storage capacitor is greater than parasitic capacitance of the control terminal of the power element.

5. The voltage regulating circuit according to claim 1, wherein the output circuit comprises:
a power element, a control terminal of the power element electrically connected to the output terminal of the error amplifier, the power element for converting the supply voltage into the output voltage.

6. The voltage regulating circuit according to claim 1, wherein the error amplifier selectively charges the tank circuit with the amplified voltage.

7. The voltage regulating circuit according to claim 1, further comprising:
an impedance circuit, electrically connected between a load contact and ground, for selectively providing an impedance to the load contact, wherein when the impedance circuit provides the impedance to the load contact, the error amplifier charges the tank circuit with the amplified voltage.

8. The voltage regulating circuit according to claim 1, further comprising:
an impedance circuit, electrically connected between a load contact and ground, for intermittently providing an impedance to the load contact according to a time interval, wherein when the impedance circuit provides the impedance to the load contact, the error amplifier charges the tank circuit with the amplified voltage.

9. The voltage regulating circuit according to claim 1, wherein the feedback circuit is a signal line, for directly providing the output voltage as the feedback voltage to the error amplifier.

10. The voltage regulating circuit according to claim 1, wherein the feedback circuit comprises:
a first resistor, electrically connected to the input terminal of the error amplifier; and
a second resistor, electrically connected between the load contact and the first resistor.

11. A voltage regulating method, comprising:
generating an amplified voltage according to a difference between a reference voltage and a feedback voltage;
providing a fixed voltage by an energy storage capacitor;
converting a supply voltage into an output voltage according to at least one of the amplified voltage and the fixed voltage; and
generating the feedback voltage according to the output voltage.

12. The voltage regulating method according to claim 11, further comprising
charging the energy storage capacitor with the amplified voltage, so that the energy storage capacitor stores the fixed voltage.

13. The voltage regulating method according to claim 11, wherein the step of charging the energy storage capacitor with the amplified voltage comprises:
intermittently charging the energy storage capacitor with the amplified voltage according to a time interval.

14. The voltage regulating method according to claim 11, wherein the step of charging the energy storage capacitor with the amplified voltage comprises:
detecting the fixed voltage; and
when a drift of the fixed voltage is greater than a threshold, charging the energy storage capacitor with the amplified voltage.

15. The voltage regulating method according to claim 11, wherein the step of charging the energy storage capacitor with the amplified voltage comprises:
electrically connecting an internal impedor to a load that outputs the output voltage; and
electrically connecting the energy storage capacitor to the amplified voltage.

16. The voltage regulating method according to claim 11, wherein the step of charging the energy storage capacitor with the amplified voltage comprises:
outputting a test signal through a signal output terminal electrically connected to the output voltage; and
electrically connecting the energy storage capacitor to the amplified voltage.

17. A voltage regulating method, applied to a wireless transmission system, wherein the wireless transmission system comprises an energy storage capacitor, a feedback loop, and a signal transmission circuit, and the voltage regulating method comprises:
at a preset stage of the wireless transmission system, connecting the energy storage capacitor to an error amplifier in the feedback loop, and charging energy storage capacitor with an amplified voltage generated by the error amplifier, wherein when the feedback loop enters a stable state, the energy storage capacitor is disconnected from the error amplifier; and
at a normal working stage of the wireless transmission system, starting the feedback loop and connecting the energy storage capacitor to a control terminal of a power element in the feedback loop, so that the power element generates an output voltage to the signal transmission circuit according to the control of the energy storage capacitor and the error amplifier.

18. The voltage regulating method according to claim 17, at the preset stage, further comprising:
connecting an impedor to an output terminal of the power element, wherein when the feedback loop enters the stable state, the impedor is disconnected from the power element.

19. The voltage regulating method according to claim 17, at the preset stage, further comprising:
transmitting a test signal by the signal transmission circuit.

20. The voltage regulating method according to claim 17, at the normal working stage, further comprising:
detecting the fixed voltage; and
when a drift of the fixed voltage is greater than a threshold, connecting the impedor to the output terminal of the power element, so that the energy storage capacitor is charged with the amplified voltage.

21. The voltage regulating method according to claim 17, at the normal working stage, further comprising:
intermittently connecting an impedor to an output terminal of the power element according to a time interval, so that the energy storage capacitor is charged with the amplified voltage.
